(19) United States
(12) Patent Application Publication
(10) Pub. No.: US 2026/0332443 A1
(43) Pub. Date: Oct. 22, 2026

(54) METHOD FOR CHARGING, APPARATUS, AND NON-TRANSITORY COMPUTER-READABLE STORAGE MEDIUM

(71) Applicant: Beijing Xiaomi Mobile Software Co., Ltd., Beijing (CN)

(72) Inventor: Jinhua WU, Beijing (CN)

(73) Assignee: Beijing Xiaomi Mobile Software Co., Ltd., Beijing (CN)

(21) Appl. No.: 19/111,384

(22) PCT Filed: Sep. 19, 2022
(86) PCT No.: PCT/CN2022/119731

§ 371 Date: Mar. 13, 2025

(51) Int. Cl. H04L 12/14; H04W 4/24

(52) U.S. Cl. CPC H04L 12/1403; H04W 4/24

(57) ABSTRACT

The present disclosure relates to a billing method, apparatus and system, and to a storage medium and a chip. The method comprises: in response to receiving a sensing request message sent by a sensing request device, a sensing application function (SAF) determining a sensing billing parameter and sending the sensing billing parameter to a billing function (CHF); the sensing billing parameter being used for instructing the CHF to bill the sensing request device. In this way, the SAF sending a sensing billing parameter can achieve within a communications system the function of billing a sensing request device.

### TECHNICAL FIELD

The present disclosure relates to the field of communication technologies, and in particular, to a method for charging, an apparatus, a system, a storage medium, and a chip.

### BACKGROUND

With the development of wireless communication technologies, the wireless sensing technology has been increasingly applied. However, in the related art, a charging solution corresponding to the wireless sensing technology is lacked.

### SUMMARY

In order to overcome the above-mentioned problems in the related art, the present disclosure provides a method for charging, an apparatus, a system, a storage medium, and a chip.

According to a first aspect of the embodiments of the present disclosure, there is provided a method for charging, applied to a sensing application function (SAF), and the method includes:
determining a sensing charging parameter in response to receiving a sensing request message sent by a sensing requester; and
sending the sensing charging parameter to a charging function (CHF), where the sensing charging parameter is used to instruct the CHF to perform charging on the sensing requester.

In some embodiments, the sensing charging parameter includes one or more of following parameters: a sensing device identifier, a sensing event type, sensing time information, sensing location information, sensing range information, sensing accuracy information, sensing frequency information, and a sensing radio access type.

In some embodiments, the sensing request message includes a sensing request parameter, and determining the sensing charging parameter in response to receiving the sensing request message sent by the sensing requester includes:
obtaining the sensing request parameter in response to receiving the sensing request message sent by the sensing requester; and
determining the sensing charging parameter according to the sensing request parameter.

In some embodiments, sending the sensing charging parameter to the charging function (CHF) includes:
sending a charging data request message to the CHF, where the charging data request message includes the sensing charging parameter.

In some embodiments, the method further includes:
determining a sensing execution device in response to receiving a charging data response message sent by the CHF; and
sending a sensing execution message to the sensing execution device, where the sensing execution message is used to instruct the sensing execution device to perform sensing measurement.

In some embodiments, the method further includes:
sending second sensing measurement data to the sensing requester in response to receiving first sensing measurement data sent by the sensing execution device.

According to a second aspect of the embodiments of the present disclosure, there is provided a method for charging, applied to a charging function (CHF), and the method includes:
receiving a sensing charging parameter sent by a sensing application function (SAF), where the sensing charging parameter is a parameter determined by the SAF in response to receiving a sensing request message sent by a sensing requester; and
performing charging on the sensing requester according to the sensing charging parameter.

In some embodiments, the sensing charging parameter includes one or more of following parameters: a sensing device identifier, a sensing event type, sensing time information, sensing location information, sensing range information, sensing accuracy information, sensing frequency information, and a sensing radio access type.

In some embodiments, receiving the sensing charging parameter sent by the sensing application function (SAF) includes:
receiving a charging data request message sent by the SAF, where the charging data request message includes the sensing charging parameter.

In some embodiments, performing charging on the sensing requester according to the sensing charging parameter includes:
establishing, according to the sensing charging parameter, a sensing charging bill for performing charging on the sensing requester; and
sending a charging data response message to the SAF in a case that the sensing charging bill is successfully established, where the charging data response message is used to instruct the SAF to determine a sensing execution device, and send a sensing execution message to the sensing execution device.

According to a third aspect of the embodiments of the present disclosure, there is provided a method for charging, and the method includes:
sending a sensing request message to a sensing application function (SAF), where the sensing request message is used to instruct the SAF to determine a sensing charging parameter, and the sensing charging parameter is used by a charging function (CHF) to perform charging on the sensing requester.

In some embodiments, sending the sensing request message to the sensing application function includes:
determining a sensing request parameter; and
sending the sensing request message to the SAF according to the sensing request parameter, where the sensing request message includes the sensing request parameter, and the sensing request parameter is used to instruct the SAF to determine the sensing charging parameter according to the sensing request parameter.

In some embodiments, the sensing request parameter includes one or more of following parameters: a sensing device identifier, a sensing event type, sensing time information, sensing location information, sensing range information, sensing accuracy information, sensing frequency information, and a sensing radio access type.

In some embodiments, the method further includes:
receiving second sensing measurement data sent by the SAF, and obtaining a sensing measurement result.

According to a fourth aspect of the embodiments of the present disclosure, there is provided a method for charging, applied to a system for charging, where the system for charging includes a sensing application function (SAF) and a charging function (CHF), and the method includes:
determining, by the SAF, a sensing charging parameter in response to receiving a sensing request message sent by a sensing requester, and sending the sensing charging parameter to the charging function (CHF), where the sensing charging parameter is used to instruct the CHF to perform charging on the sensing requester; and
receiving, by the CHF, the sensing charging parameter, and performing charging on the sensing requester according to the sensing charging parameter.

In some embodiments, the sensing charging parameter includes one or more of following parameters: a sensing device identifier, a sensing event type, sensing time information, sensing location information, sensing range information, sensing accuracy information, sensing frequency information, and a sensing radio access type.

In some embodiments, the sensing request message includes a sensing request parameter, and the method includes:
obtaining, by the SAF, the sensing request parameter in response to receiving the sensing request message sent by the sensing requester, and determining the sensing charging parameter according to the sensing request parameter.

In some embodiments, the method further includes:
establishing, by the CHF, a sensing charging bill for the sensing requester according to the sensing charging parameter, and sending a charging data response message to the SAF in a case that the sensing charging bill is successfully established; and
determining, by the SAF, a sensing execution device in response to receiving the charging data response message sent by the CHF, and sending a sensing execution message to the sensing execution device, where the sensing execution message is used to instruct the sensing execution device to perform sensing measurement.

In some embodiments, the method further includes:
sending, by the SAF, second sensing measurement data to the sensing requester in response to receiving first sensing measurement data sent by the sensing execution device.

According to a fifth aspect of the embodiments of the present disclosure, there is provided an apparatus for charging, applied to a sensing application function (SAF), and the apparatus includes:
a first determination module, configured to determine a sensing charging parameter in response to receiving a sensing request message sent by a sensing requester, and
a first sending module, configured to send the sensing charging parameter to a charging function (CHF), where the sensing charging parameter is used to instruct the CHF to perform charging on the sensing requester.

In some embodiments, the sensing charging parameter includes one or more of following parameters: a sensing device identifier, a sensing event type, sensing time information, sensing location information, sensing range information, sensing accuracy information, sensing frequency information, and a sensing radio access type.

In some embodiments, the sensing request message includes a sensing request parameter, and the first determination module is configured to: obtain the sensing request parameter in response to receiving the sensing request message sent by the sensing requester; and determine the sensing charging parameter according to the sensing request parameter.

In some embodiments, the first sending module is configured to send a charging data request message to the CHF, where the charging data request message includes the sensing charging parameter.

In some embodiments, the first determination module is further configured to determine a sensing execution device in response to receiving a charging data response message sent by the CHF; and
the first sending module is further configured to send a sensing execution message to the sensing execution device, where the sensing execution message is used to instruct the sensing execution device to perform sensing measurement.

In some embodiments, the first sending module is further configured to send second sensing measurement data to the sensing requester in response to receiving first sensing measurement data sent by the sensing execution device.

According to a sixth aspect of the embodiments of the present disclosure, there is provided an apparatus for charging, applied to a charging function (CHF), and the apparatus includes:
a second receiving module, configured to receive a sensing charging parameter sent by a sensing application function (SAF), where the sensing charging parameter is a parameter determined by the SAF in response to receiving a sensing request message sent by a sensing requester; and
a second charging module, configured to perform charging on the sensing requester according to the sensing charging parameter.

In some embodiments, the sensing charging parameter includes one or more of following parameters: a sensing device identifier, a sensing event type, sensing time information, sensing location information, sensing range information, sensing accuracy information, sensing frequency information, and a sensing radio access type.

In some embodiments, the second receiving module is configured to receive a charging data request message sent by the SAF, where the charging data request message includes the sensing charging parameter.

In some embodiments, the second charging module is configured to: establish, according to the sensing charging parameter, a sensing charging bill for performing charging on the sensing requester; and, send a charging data response message to the SAF in a case that the sensing charging bill is successfully established, where the charging data response message is used to instruct the SAF to determine a sensing execution device, and send a sensing execution message to the sensing execution device.

According to a seventh aspect of the embodiments of the present disclosure, there is provided an apparatus for charging, applied to a sensing requester, and the apparatus includes:
a third sending module, configured to send a sensing request message to a sensing application function (SAF), where the sensing request message is used to instruct the SAF to determine a sensing charging parameter, and the sensing charging parameter is used by a charging function (CHF) to perform charging on the sensing requester.

In some embodiments, the third sending module is configured to: determine a sensing request parameter; and, send the sensing request message to the SAF according to the sensing request parameter, where the sensing request message includes the sensing request parameter, and the sensing request parameter is used to instruct the SAF to determine the sensing charging parameter according to the sensing request parameter.

In some embodiments, the sensing request parameter includes one or more of following parameters: a sensing device identifier, a sensing event type, sensing time information, sensing location information, sensing range information, sensing accuracy information, sensing frequency information, and a sensing radio access type.

In some embodiments, the apparatus further includes:
a third receiving module, configured to receive second sensing measurement data sent by the SAF, and obtain a sensing measurement result.

According to an eighth aspect of the embodiments of the present disclosure, there is provided a system for charging, and the system includes:
a sensing application function (SAF), configured to determine a sensing charging parameter in response to receiving a sensing request message sent by a sensing requester, and send the sensing charging parameter to a charging function (CHF), where the sensing charging parameter is used to instruct the CHF to perform charging on the sensing requester; and
a charging function (CHF), configured to receive the sensing charging parameter, and perform charging on the sensing requester according to the sensing charging parameter.

In some embodiments, the sensing charging parameter includes one or more of following parameters: a sensing device identifier, a sensing event type, sensing time information, sensing location information, sensing range information, sensing accuracy information, sensing frequency information, and a sensing radio access type.

In some embodiments, the sensing request message includes a sensing request parameter; and the SAF is configured to: obtain the sensing request parameter in response to receiving the sensing request message sent by the sensing requester, and determine the sensing charging parameter according to the sensing request parameter.

In some embodiments, the CHF is further configured to: establish a charging bill for the sensing requester according to the sensing charging parameter, and send a charging data response message to the SAF in a case that the sensing charging bill is successfully established; and
the SAF is configured to: determine a sensing execution device in response to receiving the charging data response message sent by the CHF, and send a sensing execution message to the sensing execution device, where the sensing execution message is used to instruct the sensing execution device to perform sensing measurement.

In some embodiments, the SAF is further configured to send second sensing measurement data to the sensing requester in response to receiving first sensing measurement data sent by the sensing execution device.

According to a ninth aspect of the embodiments of the present disclosure, there is provided an apparatus for charging, and the apparatus includes:
a processor; and
a memory, configured to store an instruction executable by the processor;
where the processor is configured to perform the steps of the method for charging provided in the first aspect of the present disclosure.

According to a tenth aspect of the embodiments of the present disclosure, there is provided an apparatus for charging, and the apparatus includes:
a processor; and
a memory, configured to store an instruction executable by the processor;
where the processor is configured to perform the steps of the method for charging provided in the second aspect of the present disclosure.

According to an eleventh aspect of the embodiments of the present disclosure, there is provided an apparatus for charging, and the apparatus includes
a processor; and
a memory, configured to store an instruction executable by the processor;
where the processor is configured to perform the steps of the method for charging provided in the third aspect of the present disclosure.

According to a twelfth aspect of the embodiments of the present disclosure, there is provided a computer-readable storage medium; a computer program instruction is stored on the computer-readable storage medium; and, when the computer program instruction is executed by a processor, the steps of the method for charging provided in the first aspect of the present disclosure are implemented.

According to a thirteenth aspect of the embodiments of the present disclosure, there is provided a computer-readable storage medium, a computer program instruction is stored on the computer-readable storage medium; and, when the computer program instruction is executed by a processor, the steps of the method for charging provided in the second aspect of the present disclosure are implemented.

According to a fourteenth aspect of the embodiments of the present disclosure, there is provided a computer-readable storage medium; a computer program instruction is stored on the computer-readable storage medium; and, when the computer program instruction is executed by a processor, the steps of the method for charging provided in the third aspect of the present disclosure are implemented.

According to a fifteenth aspect of the embodiments of the present disclosure, there is provided a chip, including a processor and an interface, where the processor is configured to read an instruction to perform the steps of the method for charging provided in the first aspect of the present disclosure,

According to a sixteenth aspect of the embodiments of the present disclosure, there is provided a chip, including a processor and an interface, where the processor is configured to read an instruction to perform the steps of the method for charging provided in the second aspect of the present disclosure.

According to a seventeenth aspect of the embodiments of the present disclosure, there is provided a chip, including a processor and an interface, where the processor is configured to read an instruction to perform the steps of the method for charging provided in the third aspect of the present disclosure.

The technical solution provided in the embodiments of the present disclosure may include the following beneficial effects. The sensing application function (SAF) determines the sensing charging parameter in response to receiving the sensing request message sent by the sensing requester, and sends the sensing charging parameter to the charging function (CHF), where the sensing charging parameter may be used to instruct the CHF to perform charging on the sensing requester. In this way, by the SAF sending the sensing charging parameter, the charging function on the sensing requester in the communication system may be implemented.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of the description, illustrate embodiments consistent with the present disclosure and, together with the description, serve to explain the principles of the present disclosure.

FIG. 1 is a schematic diagram of a communication system shown according to an example embodiment.

FIG. 2 is a schematic diagram of a communication system shown according to an example embodiment.

FIG. 3 is a schematic diagram of a system for charging shown according to an example embodiment.

FIG. 4 is a flowchart of a method for charging shown according to an example embodiment.

FIG. 5 is a flowchart of a method for charging shown according to an example embodiment.

FIG. 6 is a flowchart of a method for charging shown according to an example embodiment.

FIG. 7 is a flowchart of a method for charging shown according to an example embodiment.

FIG. 8 is a flowchart of a method for charging shown according to an example embodiment.

FIG. 9 is a flowchart of a method for charging shown according to an example embodiment.

FIG. 10 is a flowchart of a method for charging shown according to an example embodiment.

FIG. 11 is a flowchart of a method for charging shown according to an example embodiment.

FIG. 12 is a block diagram of an apparatus for charging shown according to an example embodiment.

FIG. 13 is a block diagram of an apparatus for charging shown according to an example embodiment.

FIG. 14 is a block diagram of an apparatus for charging shown according to an example embodiment.

FIG. 15 is a block diagram of an apparatus for charging shown according to an example embodiment.

FIG. 16 is a block diagram of a system for charging shown according to an example embodiment.

FIG. 17 is a block diagram of an apparatus for charging shown according to an example embodiment.

### DETAILED DESCRIPTION

Example embodiments will be described in detail here, examples of which are illustrated in the accompanying drawings. The following description refers to the accompanying drawings in which the same numerals in different drawings represent the same or similar elements unless otherwise represented. The implementations described in the following example embodiments do not represent all implementations consistent with the present disclosure. By contrast, they are merely examples of apparatuses and methods consistent with some aspects of the present disclosure as detailed in the appended claims.

It should be noted that all actions for acquiring signals, information or data in the present disclosure are performed on the premise of conforming to the corresponding data protection regulation policy of the country of the location and obtaining the authorization by the owner of the corresponding apparatus.

In the description of the present disclosure, terms such as “first” and “second” used in the present disclosure are used to distinguish between similar objects, and are not necessarily to be understood as a specific order or sequence. In addition, the same reference numerals in different drawings represent the same elements in the description of the drawings unless otherwise specified.

In the description of the present disclosure, unless otherwise specified, “a plurality of” means two or more than two, and other quantifiers are similar to this. “At least one”, “one or more” or similar expressions refer to any combination of these items, including any combination of a single item or a plurality of items. For example, “at least one” may represent any number. For another example, one or more of a, b, and c may represent: a, b, c, a-b, a-c, b-c, or a-b-c, where a, b, and c may be of a singular form or a plural form. “And/or” is an association relationship for describing associated objects, indicating that there may be three relationships. For example, A and/or B may indicate that A exists alone, both A and B exist, and B exists alone, where A and B may be a singular form or a plural form.

In the embodiments of the present disclosure, although operations or steps are described in a specific order in the accompanying drawings, it should not be understood that these operations or steps are required to be performed in the specific order or serial order as shown, or all illustrated operations or steps are required to be performed to obtain a desired result. In the embodiments of the present disclosure, these operations or steps may be performed in series; or, these operations or steps may be performed in parallel; or, some of these operations or steps may be performed.

The implementation environment of the embodiments of the present disclosure is firstly described below.

The technical solutions of the embodiments of the present disclosure may be applied to various communication systems. For example, a sensing requester may be integrated into a communication system to implement the wireless sensing technology based on the communication system. The communication system may include one or more of a 4G (the 4th Generation) communication system, a 5G (the 5th Generation) communication system, and another future (such as 6G) wireless communication system. The communication system may also include one or more of a Public Land Mobile Network (PLMN) network, a Device-to-Device (D2D) communication system, a Machine to Machine (M2M) communication system, a Vehicle-to-Everything (V2X) communication system, or another communication system.

The wireless sensing technology may obtain related information of a remote object. For example, feature information of a remote object and environment information around the remote object may be may obtained to be used for data analysis. When the wireless sensing technology is applied to a communication system (for example, a 5G system), the following application manners may be provided:
environment real-time detection, such as traffic detection, pedestrian flow detection, weather detection, rainfall detection, air humidity detection, or the like;
some functional requirements of an autonomous vehicle or an unmanned aerial vehicle, such as obstacle detection;
air pollution detection, such as particulate matter concentration detection;
indoor health care detection, such as detection on the respiratory rate and vital signs of the human body; and
wireless communication channel environment detection, such as detection on the channel environment of a terminal.

It should be noted that the foregoing application manners of the wireless sensing technology are merely examples and are not intended to limit the application scenario of the embodiments of the present disclosure. The embodiments of the present disclosure may be applied to any application scenario of the wireless sensing technology.

FIG. 1 is a schematic diagram of a communication system shown according to an example embodiment. As shown in FIG. 1, the communication system may include a terminal device 150, an access network device 160, a core network device 170, and a sensing requester 180. The communication system may be configured to support a 4G network access technology, for example, a Long Term Evolution (LTE) access technology, or a 5G network access technology, such as a New Radio Access Technology (New RAT), or another future wireless communication technology. The terminal device may be connected to the access network device in a wireless manner, and the access network device may be connected to the core network device in a wireless or wired manner. The core network device and the access network device may be independent different physical devices; or, a function of the core network device may be integrated with a logical function of the access network device on a same physical device; or, partial functions of the core network device may be integrated with partial functions of the access network device on a physical device. It should be noted that, in the communication system, the number of the terminal device, the number of the access network device, the number of the core network device, and the number of the sensing requester may each be one or more. The number of the terminal device, the number of the access network device, the number of the core network device, and the number of the sensing requester in the communication system shown in FIG. 1 is merely an adaptive example, which is not limited in the present disclosure. An interconnection may be established in a wired or wireless manner between the terminal device and the terminal device, or between the access network device and the access network device, or between the core network device and the core network device, or between the sensing requester and the sensing requester.

The terminal device in FIG. 1 may be an electronic device providing voice or data connectivity. For example, the terminal device may also be referred to as user equipment (UE), a subscriber unit, a mobile station, a station, a terminal, or the like. For example, the terminal device may include a smart phone, a smart wearable device, a smart speaker, a smart tablet, a modem, a wireless local loop (WLL) station, a personal digital assistant (PDA), a customer premise equipment (CPE), or the like. With the development of wireless communication technologies, a device that may access in an access communication system, may communicate with an access network device of a communication system, and may communicate with another object by using a communication system, or a device that may directly communicate between two or more devices, may be the terminal device in the embodiments of the present disclosure, such as a terminal and an automobile in intelligent transportation, a household device in smart home, a power meter reading instrument in a smart grid, a voltage monitoring instrument, an environment monitoring instrument, a video monitoring instrument in an intelligent security network, a cash register, or the like. In the embodiments of the present disclosure, the terminal device may communicate with the access network device, or the terminal device may communicate with the core network device by using the access network device. Communication may also be performed between a plurality of terminal devices. The terminal device may be statically fixed or movable, which is not limited in the present disclosure.

The access network device in FIG. 1 may be configured to support access of the terminal device. For example, the access network device may be an evolved NodeB (eNB or eNodeB) in LTE. The access network device may also be a next generation Node B (gNB, or gNodeB) in 5G network. The access network device may also be a radio access network (Next Generation Radio Access Network, NG-RAN) device in 5G network. The access network device may also be a base station, a broadband network gateway (BNG), a convergence switch or a non-3GPP (3rd Generation Partnership Project) access device in the future evolved public land mobile network (PLMN). Optionally, the access network device in the embodiments of the present disclosure may include various forms of base stations, for example, a macro base station, a micro base station (also referred to as a small station), a relay station, an access point, a 5G base station or a future base station, a satellite, a transmitting and receiving point (TRP), a transmitting point (TP), a mobile switching center, and a device for performing the function of a base station in Device to Device (D2D), Machine-to-Machine (M2M), Internet of Things (IoT), Vehicle-to-Everything (V2X) or other communication, etc., which is not specifically limited in the embodiments of the present disclosure. For ease of description, in all embodiments of the present disclosure, the apparatus that provides a wireless communication function for thee terminal device is collectively referred to as an access network device or a base station.

In some embodiments, the terminal device and the access network device may have a sensing measurement function, or may perform the sensing measurement function by using a sensor after the terminal device and the access network device are connected to the specific sensor. For example, the feature information of a remote object and the environment information around the remote object may be obtained through a specific sensor.

The core network device in FIG. 1 may be configured to perform one or more of functions such as mobility management, call control, session management, registration authentication, and charging on the terminal device. The core network device may include one or more entities. The entity may be hardware, or may be software divided by functionality or a structure combined of hardware and software. It should be noted that the entity may also be referred to as a function.

The sensing requester in FIG. 1 may be configured to send a sensing request message to the core network device, and/or, receive sensing measurement data sent by the core network device, so as to perform the sensing service.

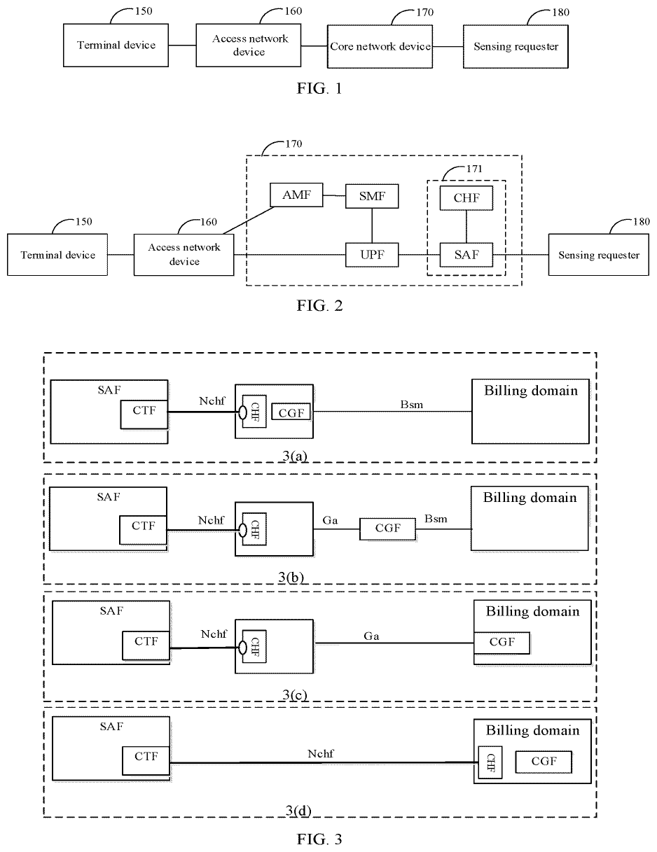

FIG. 2 is a schematic diagram of another communication system shown according to an example embodiment. As shown in FIG. 2, the core network device 170 in the communication system may include an access and mobility management function (AMF), a session management function (SMF), a user plane function (UPF), and a system 171 for charging, where the system for charging may be configured to perform charging on the sensing requester. It should be noted that the AMF, the SMF, the UPF, and the system for charging may be hardware, software by functionality, or a structure combined of hardware and software. For specific functions and implementations of the AMF, the SMF, and the UPF, reference may be made to related descriptions in the 3GPP protocol, which are not described here again.

In some embodiments of the present disclosure, the system 171 for charging may include a sensing application function (SAF) and a charging function (CHF).

Among them, the sensing application function (SAF) may include a function, a network element, or an entity that provides a sensing-related service for the sensing requester, for example, which may perform authentication and authorization for the sensing requester, and may also configure the sensing measurement parameter and send the sensing measurement parameter to a sensing execution device to instruct the sensing execution device to perform sensing measurement. The sensing execution device may include one or more of a terminal device, an access network device, and a core network device. The sensing measurement parameter may include a location, a range, a time point, a sensing measurement object, or the like.

The charging function (CHF) may include a function, a network element, or an entity that provides a charging service for the sensing requester. The CHF may also provide a charging service for a terminal device in the foregoing communication system or a user. For example, the CHF may collect, format, transmit, and evaluate specific charging information (information related to charging) to perform offline charging or online charging on the user.

For example, the SAF may send a sensing charging parameter to the CHF, and the CHR may perform charging on the sensing requester based on the sensing charging parameter.

FIG. 3 is a schematic diagram of a system for charging shown according to an example embodiment. As shown in FIG. 3, the system for charging may include a SAF and a CHF. The system for charging may have a plurality of networking structures. For example, the networking structure of the system for charging may be any one of the networking structures shown in 3(a), 3(b), 3(c), and 3(d), which are respectively described as follows.

In the networking structure of the system for charging shown in FIG. 3(a), the SAF may include a charging trigger function (CTF). The CHF and a CGF (Charging Gateway Function) may be combined and provided on a same physical entity. The SAF may be connected to and communicate with the CHF through the CTF. For example, an interface for communication between the CTF and the CHF may be a Nchf interface. The CGF may be connected to and communicate with a billing domain. For example, an interface for communication between the CGF and the billing domain may be a Bsm interface.

In the networking structure of the system for charging shown in 3(b), the SAF may include a CTF. The CHF and a CGF may be two independent physical entities. The SAF may be connected to and communicate with the CHF through the CTF. For example, an interface for communication between the CTF and the CHF may be a Nchf interface. The CHF may be connected to and communicate with the CGF. For example, an interface for communication between the CHF and the CGF may be a Ga interface. The CGF may be connected to and communicate with a billing domain. For example, an interface for communication between the CGF and the billing domain may be a Bsm interface.

In the networking structure of the system for charging shown in 3(c), the SAF may include a CTF. A CGF and a billing domain may be combined and provided on a same physical entity. The SAF may be connected to and communicate with the CHF through the CTF. For example, an interface for communication between the CTF and the CHF may be a Nchf interface. The CHF may be connected to and communicate with the CGF. For example, an interface for communication between the CHF and the CGF may be a Ga interface.

In the networking structure of the system for charging shown in 3(d), the SAF may include a CTF. The CHF, a CGF, and a billing domain may be combined and provided on a same physical entity. The SAF may be connected to and communicate with the CHF through the CTF. For example, an interface for communication between the CTF and the CHF may be a Nchf interface.

It should be noted that specific functions and implementations of the CTF, the CGF, the billing domain, the Nchf interface, the Ga interface, and the Bsm interface may refer to related descriptions in the 3GPP protocol, and details are not described here again.

The method for charging provided in the embodiments of the present disclosure may be applied to the system for charging of any one of the foregoing networking structures.

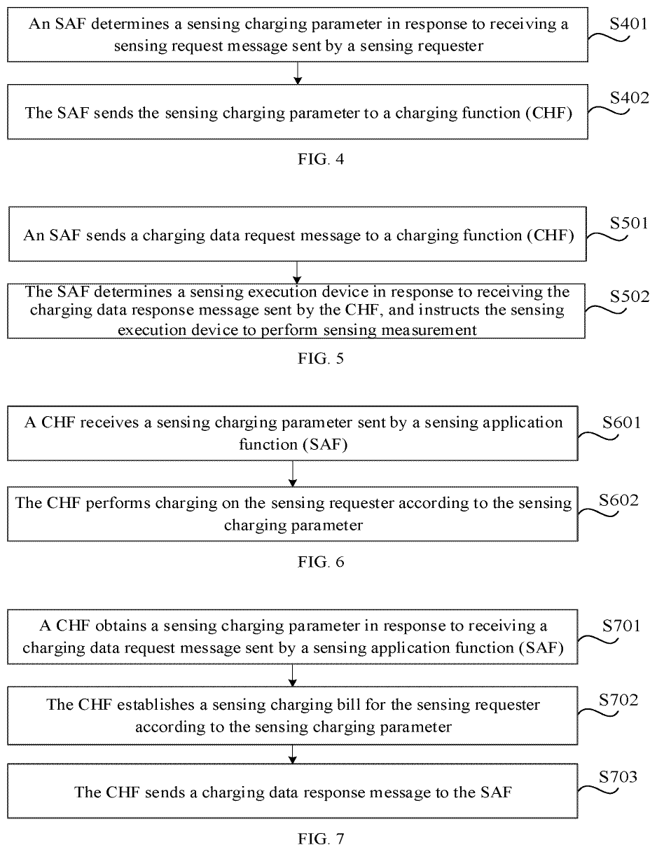

FIG. 4 is a flowchart of a method for charging shown according to an example embodiment. The method may be applied to a sensing application function (SAF) in the communication system shown in FIG. 2. As shown in FIG. 4, the method may include following steps.

In step S401, the SAF determines a sensing charging parameter in response to receiving a sensing request message sent by a sensing requester.

In step S402, the SAF sends the sensing charging parameter to a charging function (CHF).

Among them, the sensing charging parameter may be used to instruct the CHF to perform charging on the sensing requester.

In some embodiments, the SAF may send the sensing charging parameter to the CHF through a target charging interface, where the target charging interface may be an interface established between the SAF and the CHF based on a target charging protocol. For example, the target charging interface may be a Nchf interface.

In some embodiments, the SAF may include a CTF, and may send the sensing charging parameter to the CHF through the CTF. For example, the SAF may send the sensing charging parameter to the CHF through a Nchf interface between the CTF and the CHF.

In some embodiments, the SAF may send the sensing charging parameter to the CHF through a charging data request message. For example, the SAF may send a charging data request message to the CHF, where the charging data request message includes the sensing charging parameter.

In an implementation, the charging data request message may further include a charging type. The charging type may be an event type, a traffic type, or a duration type. Among them, the event type may be used to instruct the CHF to perform charging based on an event (for example, pay-per-view) on the sensing requester; the traffic type may be used to instruct the CHF to perform charging based on a sensing service traffic on the sensing requester, and, the duration type may be used to instruct the CHF to perform charging based on a sensing duration on the sensing requester.

In the foregoing method, the sensing application function (SAF) determines the sensing charging parameter in response to receiving the sensing request message sent by the sensing requester, and sends the sensing charging parameter to the charging function (CHF), where the sensing charging parameter may be used to instruct the CHF to perform charging on the sensing requester. In this way, by the SAF sending the sensing charging parameter, the charging function on the sensing requester in the communication system may be implemented.

In some embodiments, the sensing charging parameter may include one or more of the following parameters: a sensing device identifier, a sensing event type, sensing time information, sensing location information, sensing range information, sensing accuracy information, sensing frequency information, and a sensing radio access type.

The sensing device identifier is used to indicate an identifier of the sensing requester, for example, an International Mobile Subscriber Identity (IMSI), a subscriber permanent identifier (SUPI), a subscription concept identifier (SUCI), or other identification information capable of uniquely identifying the sensing requester.

The sensing event type is used to indicate a type of a sensing event (for example, rainfall) requested by the sensing requester.

The sensing time information is used to indicate a time point (for example, 10 Am of Beijing time) corresponding to a sensing event requested by the sensing requester.

The sensing location information is used to indicate a location (for example, the longitude and latitude) corresponding to a sensing event requested by the sensing requester.

The sensing range information is used to indicate a region range (for example, a range with a radius of 1 kilometer) corresponding to a sensing event requested by the sensing requester.

The sensing accuracy information is used to indicate a measurement precision requirement corresponding to a sensing event requested by the sensing requester. For example, the sensing measurement precision is 5 mm.

The sensing frequency information is used to indicate a specific frequency used by the sensing execution device, or a spectrum type (for example, an authorization frequency or an unlicensed frequency) used by the sensing execution device.

The sensing radio access type is used to indicate a radio access type (RAT) used by the sensing execution device, for example, NR (New Radio) or EUTRA (Evolved Universal Terrestrial Radio Accesss).

In this way, by using one or more of the foregoing sensing charging parameters, the CHF may be instructed to perform charging on the sensing requester.

In some embodiments of the present disclosure, the sensing request message includes a sensing request parameter. In this way, the SAF may obtain the sensing request parameter in response to receiving the sensing request message sent by the sensing requester, and determine the sensing charging parameter according to the sensing request parameter.

Among them, the sensing request parameter may also include one or more of the foregoing parameters: the sensing device identifier, the sensing event type, the sensing time information, the sensing location information, the sensing range information, the sensing accuracy information, the sensing frequency information, and the sensing radio access type.

In some implementations, the sensing charging parameter may be the same as the sensing request parameter.

In some other implementations, the sensing charging parameter may be a subset of the sensing request parameter. For example, the SAF may select some of the plurality of parameters included in the sensing request parameter as the sensing charging parameter.

In some other implementations, the sensing charging parameter may include the sensing request parameter and other parameters. For example, the SAF may combine the identification information of the SAF with the sensing request parameter to obtain the sensing charging parameter, or may combine the identification information of the SAF with some parameters in the sensing request parameter to obtain the sensing charging parameter.

It should be noted that the sensing charging parameter may be referred to as a sensing charging criterion, and the sensing request parameter may also be referred to as a sensing request criterion.

FIG. 5 is a flowchart of a method for charging shown according to an example embodiment. As shown in FIG. 5, the method may include following steps.

In step S501, the SAF sends a charging data request message to the charging function (CHF).

Among them, the charging data request message includes the sensing charging parameter

In step S502, the SAF determines a sensing execution device in response to receiving the charging data response message sent by the CHF, and instructs the sensing execution device to perform sensing measurement.

The sensing execution device may include a terminal device and/or an access network device. The sensing execution device may be one or more. For example, the sensing execution device may be a terminal device for measuring rainfall, or may be a plurality of terminal devices for measuring rainfall.

In some embodiments, in the case that the sensing execution device is determined, the SAF may send a sensing execution message to the sensing execution device, where the sensing execution message may be used to instruct the sensing execution device to perform sensing measurement.

In some other embodiments, the SAF may further send second sensing measurement data to the sensing requester in response to receiving first sensing measurement data sent by the sensing execution device.

Among them, the first sensing measurement data may be data obtained after by the sensing execution device performs sensing measurement according to the sensing execution message.

The SAF may determine the second sensing measurement data based on the received first sensing measurement data. The second sensing measurement data may be the same as or different from the first sensing measurement data.

In some implementations, the second sensing measurement data may be the same as the first sensing measurement data.

In some other implementations, the second sensing measurement data may be a subset of the first sensing measurement data. For example, the SAF may select partial data from the first sensing measurement data as the second sensing measurement data.

In some other implementations, the second sensing measurement data may include the first sensing measurement data and other parameters. For example, the SAF may combine the identification information of the SAF with the first sensing measurement data to obtain the second sensing measurement data, or may combine the identification information of the SAF with partial data in the first sensing measurement data to obtain the second sensing measurement data.

FIG. 6 is a flowchart of a method for charging shown according to an example embodiment. The method may be applied to the charging function (CHF) in the communication system shown in FIG. 2. As shown in FIG. 6, the method may include following steps.

In step S601, the CHF receives a sensing charging parameter sent by a sensing application function (SAF).

In some embodiments, the sensing charging parameter is a parameter determined by the SAF in response to receiving a sensing request message sent by a sensing requester.

In some embodiments, the CHF may obtain the sensing charging parameter by using a charging data request message. For example, the CHF may receive a charging data request message sent by the SAF, where the charging data request message may include the sensing charging parameter.

In step S602, the CHF performs charging on the sensing requester according to the sensing charging parameter.

In some embodiments, the CHF may establish, according to the sensing charging parameter, a sensing charging bill for performing charging on the sensing requester. The sensing charging bill may also be referred to as a charging data record (CDR).

In some other embodiments, the CHR may send a charging data response message (for example, a charging data response) to the SAF in the case that the sensing charging bill is successfully established, where the charging data response message may be used to instruct the SAF to determine a sensing execution device, and send a sensing execution message to the sensing execution device.

In the foregoing method, the CHF may receive the sensing charging parameter sent by the sensing application function (SAF), and perform charging on the sensing requester based on the sensing charging parameter, where the sensing charging parameter is a charging parameter determined by the SAF in response to receiving the sensing request message sent by the sensing requester. In this way, by the CHF receiving the sensing charging parameter, the charging function on the sensing requester in the communication system may be implemented.

In some embodiments of the present disclosure, the sensing charging parameter may include one or more of the following parameters: a sensing device identifier, a sensing event type, sensing time information, sensing location information, sensing range information, sensing accuracy information, sensing frequency information, and a sensing radio access type.

FIG. 7 is a flowchart of a method for charging shown according to an example embodiment. As shown in FIG. 7, the method may include following steps.

In step S701, the CHF obtains a sensing charging parameter in response to receiving a charging data request message sent by a sensing application function (SAF).

In step S702, the CHF establishes a sensing charging bill for the sensing requester according to the sensing charging parameter.

In step S703, the CHF sends a charging data response message to the SAF.

Among them, the charging data response message may be used to instruct the SAF to determine a sensing execution device, and send a sensing execution message to the sensing execution device.

In this way, through the foregoing method, the CHF may perform charging on the sensing requester.

FIG. 8 is a flowchart of a method for charging shown according to an example embodiment. The method may be applied to a sensing requester in the communication system shown in FIG. 2. As shown in FIG. 8, the method may include the following step.

In step S801, a sensing requester sends a sensing request message to a sensing application function (SAF).

Among them, the sensing request message may be used to instruct the SAF to determine a sensing charging parameter, and the sensing charging parameter may be used by a charging function (CHF) to perform charging on the sensing requester.

In some embodiments, the SAF may determine the sensing charging parameter according to the sensing request message, and send the sensing charging parameter to the CHF. The sensing charging parameter may be used to instruct the CHF to perform charging on the sensing requester.

In the foregoing method, the sensing requester sends the sensing request message to the SAF, so that the charging function on the sensing requester may be implemented based on the communication system.

In some embodiments, the sensing requester may determine a sensing request parameter, and send the sensing request message to the sensing application function according to the sensing request parameter.

Among them, the sensing request message may include the sensing request parameter, and the sensing request parameter may be used to instruct the SAF to determine the sensing charging parameter according to the sensing request parameter.

In some embodiments, the sensing request parameter may include one or more of the following parameters: a sensing device identifier, a sensing event type, sensing time information, sensing location information, sensing range information, sensing accuracy information, sensing frequency information, and a sensing radio access type.

In some embodiments, the sensing requester may further receive second sensing measurement data sent by the sensing application function, and obtain a sensing measurement result according to the second sensing measurement data. Therefore, the sensing measurement may be completed.

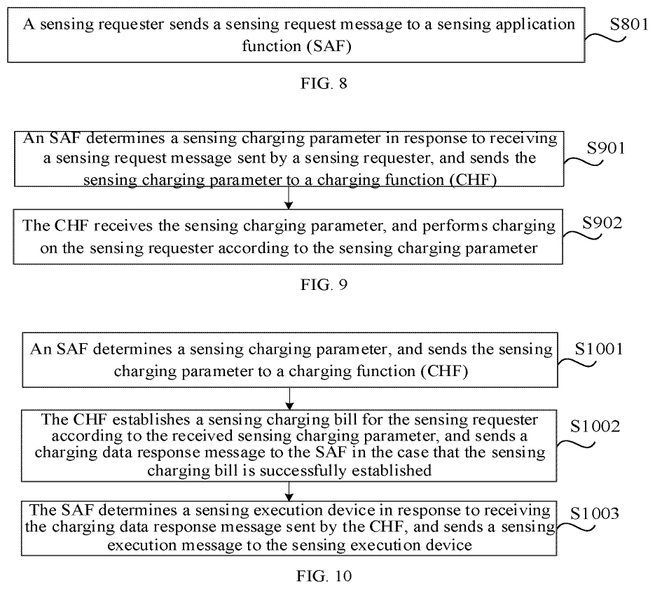

FIG. 9 is a flowchart of a method for charging shown according to an example embodiment. The method may be applied to a system for charging in the communication system shown in FIG. 2, and the system for charging may include a sensing application function (SAF) and a charging function (CHF). As shown in FIG. 9, the method may include following steps.

In step S901, the SAF determines a sensing charging parameter in response to receiving a sensing request message sent by a sensing requester, and sends the sensing charging parameter to the charging function (CHF).

Among them, the sensing charging parameter is used to instruct the CHF to perform charging on the sensing requester.

In step S902, the CHF receives the sensing charging parameter, and performs charging on the sensing requester according to the sensing charging parameter.

In the foregoing method, by using the system for charging, charging may be performed on the sensing requester.

In some embodiments, the sensing charging parameter may include one or more of the following parameters: a sensing device identifier, a sensing event type, sensing time information, sensing location information, sensing range information, sensing accuracy information, sensing frequency information, and a sensing radio access type.

In some embodiments, the sensing request message may include a sensing request parameter. The SAF may obtain the sensing request parameter in response to receiving the sensing request message sent by the sensing requester, and determine the sensing charging parameter according to the sensing request parameter.

FIG. 10 is a flowchart of a method for charging shown according to an example embodiment. As shown in FIG. 10, the method may include following steps.

In step S1001, the SAF determines a sensing charging parameter, and sends the sensing charging parameter to the charging function (CHF).

In step S1002, the CHF establishes a sensing charging bill for the sensing requester according to the received sensing charging parameter, and sends a charging data response message to the SAF in the case that the sensing charging bill is successfully established.

In step S1003, the SAF determines a sensing execution device in response to receiving the charging data response message sent by the CHF, and sends a sensing execution message to the sensing execution device.

Among them, the sensing execution message is used to instruct the sensing execution device to perform sensing measurement.

In some embodiments, the SAF may further send second sensing measurement data to the sensing requester in response to receiving first sensing measurement data sent by the sensing execution device.

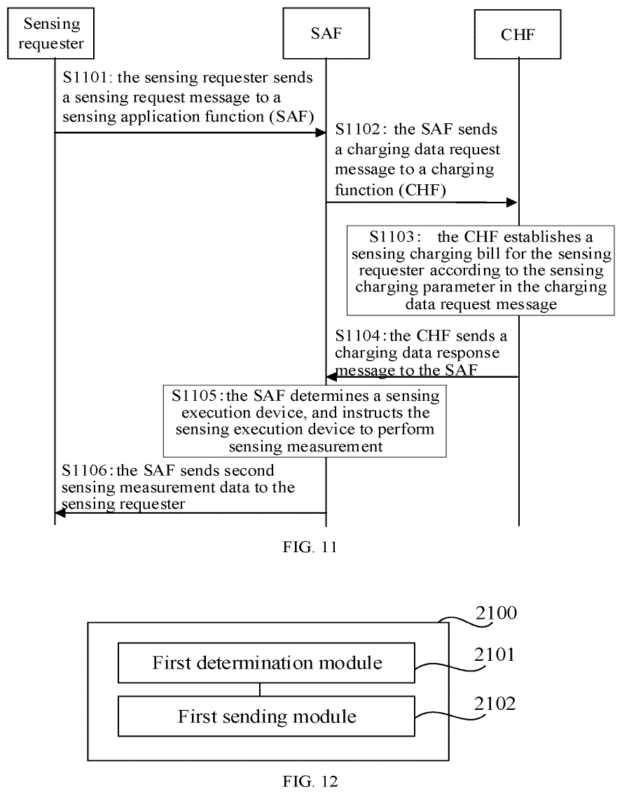

FIG. 11 is a flowchart of a method for charging shown according to an example embodiment. As shown in FIG. 11, the method may include following steps.

In step S1101, a sensing requester sends a sensing request message to a sensing application function (SAF).

In some embodiments, the sensing request message may include a sensing request parameter. The sensing request parameter may include one or more of the following parameters: a sensing device identifier, a sensing event type, sensing time information, sensing location information, sensing range information, sensing accuracy information, sensing frequency information, and a sensing radio access type.

In step S1102, the SAF sends a charging data request message to a charging function (CHF).

Among them, the charging data request message includes a sensing charging parameter.

In some embodiments, the SAF may determine the sensing charging parameter in response to receiving the sensing request message sent by the sensing requester, and the sensing charging parameter may be carried in the charging data request message.

In some embodiments, the sensing charging parameter may be the same as or different from the sensing request parameter.

In step S1103, the CHF establishes a sensing charging bill for the sensing requester according to the sensing charging parameter in the charging data request message.

In step S1104, the CHF sends a charging data response message to the SAF.

In some embodiments, the CHF may send a charging data response message to the SAF in the case that the sensing charging bill is established successfully.

In step S1105, the SAF determines a sensing execution device, and instructs the sensing execution device to perform sensing measurement.

In some embodiments, the SAF may determine the sensing execution device in response to receiving the charging data response message sent by the CHF, and instruct the sensing execution device to perform sensing measurement.

In step S1106, the SAF sends second sensing measurement data to the sensing requester.

In some embodiments, the SAF may send the second sensing measurement data to the sensing requester in response to receiving first sensing measurement data sent by the sensing execution device.

In the foregoing manner, through message interaction between the SAF and the CHF, charging may be performed on the sensing requester.

FIG. 12 is a block diagram of an apparatus 2100 for charging shown according to an example embodiment. The apparatus for charging may be applied to a sensing application function (SAF). As shown in FIG. 12, the apparatus 2100 may include a first determination module 2101 and a first sending module 2102.

The first determination module 2101 is configured to determine a sensing charging parameter in response to receiving a sensing request message sent by a sensing requester.

The first sending module 2102 is configured to send the sensing charging parameter to a charging function (CHF), where the sensing charging parameter is used to instruct the CHF to perform charging on the sensing requester.

In some embodiments, the sensing charging parameter includes one or more of the following parameters: a sensing device identifier, a sensing event type, sensing time information, sensing location information, sensing range information, sensing accuracy information, sensing frequency information, and a sensing radio access type.

In some embodiments, the sensing request message includes a sensing request parameter. The first determination module 2101 is configured to: obtain the sensing request parameter in response to receiving the sensing request message sent by the sensing requester; and, determine the sensing charging parameter according to the sensing request parameter.

In some embodiments, the first sending module 2102 is configured to send a charging data request message to the CHF, where the charging data request message includes the sensing charging parameter.

In some embodiments, the first determination module 2101 is further configured to determine a sensing execution device in response to receiving a charging data response message sent by the CHF.

The first sending module 2102 is further configured to send a sensing execution message to the sensing execution device, where the sensing execution message is used to instruct the sensing execution device to perform sensing measurement.

In some embodiments, the first sending module 2102 is further configured to send second sensing measurement data to the sensing requester in response to receiving first sensing measurement data sent by the sensing execution device.

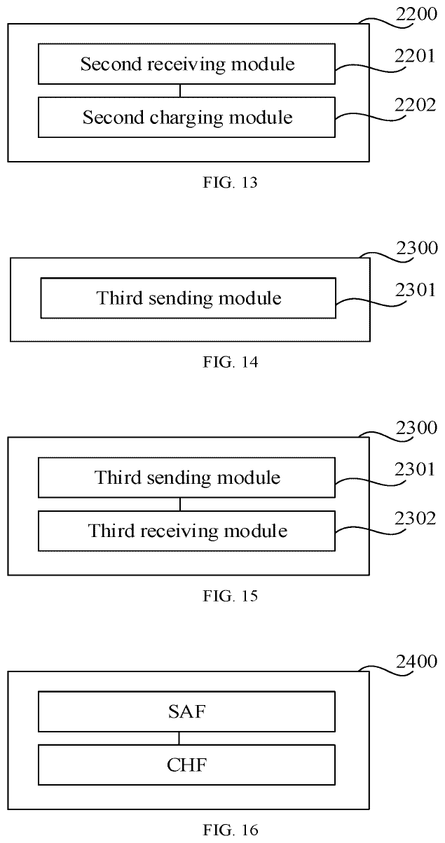

FIG. 13 is a block diagram of an apparatus 2200 for charging shown according to an example embodiment. The apparatus for charging may be applied to a charging function (CHF). As shown in FIG. 13, the apparatus 2200 may include a second receiving module 2201 and second charging module 2202.

The second receiving module 2201 is configured to receive a sensing charging parameter sent by a sensing application function (SAF), where the sensing charging parameter is a parameter determined by the SAF in response to receiving a sensing request message sent by a sensing requester.

The second charging module 2202 is configured to perform charging on the sensing requester according to the sensing charging parameter.

In some embodiments, the sensing charging parameter includes one or more of the following parameters: a sensing device identifier, a sensing event type, sensing time information, sensing location information, sensing range information, sensing accuracy information, sensing frequency information, and a sensing radio access type.

In some embodiments, the second receiving module 2201 is configured to receive a charging data request message sent by the SAF, where the charging data request message includes the sensing charging parameter.

In some embodiments, the second charging module 2202 is configured to: establish a sensing charging bill for performing charging on the sensing requester according to the sensing charging parameter; and send a charging data response message to the SAF in a case that the sensing charging bill is successfully established; where the charging data response message is used to instruct the SAF to determine a sensing execution device, and send a sensing execution message to the sensing execution device.

FIG. 14 is a block diagram of an apparatus 2300 for charging shown according to an example embodiment. The apparatus for charging may be applied to a sensing requester. As shown in FIG. 14, the apparatus 2300 may include a third sending module 2301.

The third sending module 2301 is configured to send a sensing request message to a sensing application function (SAF), where the sensing request message is used to instruct the SAF to determine a sensing charging parameter, and the sensing charging parameter is used by a charging function (CHF) to perform charging on the sensing requester.

In some embodiments, the third sending module 2301 is configured to: determine a sensing request parameter, and send the sensing request message to the SAF according to the sensing request parameter; where the sensing request message includes the sensing request parameter, and the sensing request parameter is used to instruct the SAF to determine the sensing charging parameter according to the sensing request parameter.

In some embodiments, the sensing request parameter includes one or more of the following parameters: a sensing device identifier, a sensing event type, sensing time information, sensing location information, sensing range information, sensing accuracy information, sensing frequency information, and a sensing radio access type.

FIG. 15 is a block diagram of the apparatus 2300 for charging shown according to an example embodiment. As shown in FIG. 15, the apparatus 2300 may further include a third receiving module 2302.

The third receiving module 2302 is configured to receive second sensing measurement data sent by the SAF, and obtain a sensing measurement result.

With regard to the apparatus in the above embodiments, the specific manner in which the various modules perform operations has been described in detail in the embodiments of the related methods, which will not be described in detail here.

FIG. 16 is a block diagram of a system 2400 for charging shown according to an example embodiment. As shown in FIG. 16, the system 2400 for charging may include a sensing application function (SAF) and a charging function (CHF).

The sensing application function (SAF) is configured to: determine a sensing charging parameter in response to receiving a sensing request message sent by a sensing requester; and, send the sensing charging parameter to the charging function (CHF), where the sensing charging parameter is used to instruct the CHF to perform charging on the sensing requester.

The charging function (CHF) is configured to receive the sensing charging parameter, and perform charging on the sensing requester according to the sensing charging parameter.

In some embodiments, the sensing charging parameter includes one or more of the following parameters: a sensing device identifier, a sensing event type, sensing time information, sensing location information, sensing range information, sensing accuracy information, sensing frequency information, and a sensing radio access type.

In some embodiments, the sensing request message includes a sensing request parameter. The SAF is configured to obtain the sensing request parameter in response to receiving the sensing request message sent by the sensing requester, and determine the sensing charging parameter according to the sensing request parameter.

In some embodiments, the CHF is further configured to establish a sensing charging bill for the sensing requester according to the sensing charging parameter, and send a charging data response message to the SAF in a case that the sensing charging bill is successfully established.

In response to receiving the charging data response message sent by the CHF, the SAF determines a sensing execution device, and sends a sensing execution message to the sensing execution device, where the sensing execution message is used to instruct the sensing execution device to perform sensing measurement.

In some embodiments, the SAF is further configured to send second sensing measurement data to the sensing requester in response to receiving first sensing measurement data sent by the sensing execution device.

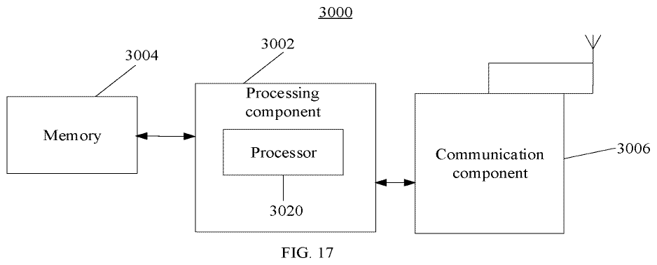

FIG. 17 is a block diagram of an apparatus for charging shown according to an example embodiment. The apparatus 3000 for charging may be a sensing application function (SAF), a charging function (CHF), or a sensing requester in the communication system shown in FIG. 1.

Referring to FIG. 17, the apparatus 3000 may include one or more of the following components: a processing component 3002, a memory 3004, and a communication component 3006.

The processing component 3002 may be configured to control overall operations of the apparatus 3000, such as operations associated with display, telephone calls, data communications, camera operations, and recording operations. The processing component 3002 may include one or more processors 3020 to execute instructions to complete all or part of the steps of the foregoing method for charging. In addition, the processing component 3002 may include one or more modules which facilitate the interaction between the processing component 3002 and other components. For example, the processing component 3002 may include a multimedia module to facilitate interaction between a multimedia component and the processing component 3002.

The memory 3004 is configured to store various types of data to support the operation of the apparatus 3000. Examples of such data include instructions for any application or method operating on the apparatus 3000, contact data, phonebook data, messages, pictures, videos, etc. The memory 3004 may be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The communication component 3006 is configured to facilitate wired or wireless communication between the apparatus 3000 and other devices. The apparatus 3000 may access a wireless network based on a communication standard, such as Wi-Fi, 2G, 3G, 4G, 5G, 6G, NB-IoT, eMTC, or the like, or a combination of them. In an example embodiment, the communication component 3006 receives a broadcast signal or broadcast related information from an external broadcast management system via a broadcast channel. In an example embodiment, the communication component 3006 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an example embodiment, the apparatus 3000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the above-described method for charging.

The apparatus 3000 may be an independent electronic device, or may be a part of an independent electronic device. For example, in an embodiment, the electronic device may be an integrated circuit (IC) or a chip, where the integrated circuit may be an IC or a set of a plurality of ICs. The chip may include, but is not limited to, a Graphics Processing Unit (GPU), a Central Processing Unit (CPU), a Field Programmable Gate Array (FPGA), a Digital Signal Processor (DSP), an Application Specific Integrated Circuit (ASIC), a System on Chip (SOC), etc. The integrated circuit or chip may be configured to execute an executable instruction (or code) to implement the foregoing method for charging. Among them, the executable instruction may be stored in the integrated circuit or the chip, or may be obtained from another apparatus or device. For example, the integrated circuit or the chip includes a processor, a memory, and an interface configured for communicating with another apparatus. The executable instruction may be stored in the processor, and the foregoing method for charging may be implemented when the executable instruction is executed by the processor; or, the integrated circuit or the chip may receive an executable instruction through the interface and transmit the executable instruction to the processor for execution, to implement the foregoing method for charging.

In an example embodiment, the present disclosure further provides a computer-readable storage medium, on which a computer program instruction is stored. When the program instruction is executed by a processor, the steps of the method for charging provided in the present disclosure are implemented. For example, the computer-readable storage medium may be a non-transitory computer-readable storage medium including an instruction, for example, may be the memory 3004 including an instruction. The instruction may be executed by the processor 3020 of the apparatus 3000 to complete the foregoing method for charging. For example, the non-transitory computer-readable storage medium may be a ROM, a random access memory (RAM), a CD-ROM, a magnetic tape, a floppy disk, an optical data storage device, or the like.

In another example embodiment, there is further provided a computer program product including a computer program executable by a programmable apparatus, and the computer program has a code portion for performing the method for charging described above when executed by the programmable apparatus.

Other embodiments of the present disclosure will be apparent to those skilled in the art from consideration of the description and practice of the present disclosure. The present application is intended to cover any variations, uses, or adaptations of the present disclosure following the general principles of the present disclosure and including common general knowledge and conventional technical means in the art not disclosed in the present disclosure. The description and examples should be considered as examples only, with a true scope and spirit of the present disclosure being indicated by the following claims.

It should be understood that the present disclosure is not limited to the precise structures that have been described above and shown in the accompanying drawings, and various modifications and changes may be made without departing from the scope of the present disclosure. The scope of the present disclosure is only limited by the appended claims.

What is claimed is:

1. A method for charging, applied to a sensing application function (SAF), wherein the method comprises:
determining a sensing charging parameter in response to receiving a sensing request message sent by a sensing requester; and
sending the sensing charging parameter to a charging function (CHF), wherein the sensing charging parameter is used to instruct the CHF to perform charging on the sensing requester.

2. The method according to claim 1, wherein the sensing charging parameter comprises one or more of following parameters: a sensing device identifier, a sensing event type, sensing time information, sensing location information, sensing range information, sensing accuracy information, sensing frequency information, and a sensing radio access type.

3. The method according to claim 1, wherein the sensing request message comprises a sensing request parameter, and determining the sensing charging parameter in response to receiving the sensing request message sent by the sensing requester comprises:
obtaining the sensing request parameter in response to receiving the sensing request message sent by the sensing requester; and
determining the sensing charging parameter according to the sensing request parameter.

4. The method according to any one of claims 1 to 3, wherein sending the sensing charging parameter to the charging function (CHF) comprises:
sending a charging data request message to the CHF, wherein the charging data request message comprises the sensing charging parameter.

5. The method according to claim 4, further comprising:
determining a sensing execution device in response to receiving a charging data response message sent by the CHF; and
sending a sensing execution message to the sensing execution device, wherein the sensing execution message is used to instruct the sensing execution device to perform sensing measurement.

6. The method according to claim 5, further comprising:
sending second sensing measurement data to the sensing requester in response to receiving first sensing measurement data sent by the sensing execution device.

7. A method for charging, applied to a charging function (CHF), wherein the method comprises:
receiving a sensing charging parameter sent by a sensing application function (SAF), wherein the sensing charging parameter is a parameter determined by the SAF in response to receiving a sensing request message sent by a sensing requester; and
performing charging on the sensing requester according to the sensing charging parameter.

8. The method according to claim 7, wherein the sensing charging parameter comprises one or more of following parameters: a sensing device identifier, a sensing event type, sensing time information, sensing location information, sensing range information, sensing accuracy information, sensing frequency information, and a sensing radio access type.

9. The method according to claim 7 or 8, wherein receiving the sensing charging parameter sent by the sensing application function (SAF) comprises:
receiving a charging data request message sent by the SAF, wherein the charging data request message comprises the sensing charging parameter.

10. The method according to claim 9, wherein performing charging on the sensing requester according to the sensing charging parameter comprises:
establishing, according to the sensing charging parameter, a sensing charging bill for performing charging on the sensing requester; and
sending a charging data response message to the SAF in a case that the sensing charging bill is successfully established, wherein the charging data response message is used to instruct the SAF to determine a sensing execution device, and send a sensing execution message to the sensing execution device.

11. A method for charging, applied to a sensing requester, wherein the method comprises:
sending a sensing request message to a sensing application function (SAF), wherein the sensing request message is used to instruct the SAF to determine a sensing charging parameter, and the sensing charging parameter is used by a charging function (CHF) to perform charging on the sensing requester.

12. The method according to claim 11, wherein sending the sensing request message to the sensing application function comprises:
determining a sensing request parameter; and
sending the sensing request message to the SAF according to the sensing request parameter, wherein the sensing request message comprises the sensing request parameter, and the sensing request parameter is used to instruct the SAF to determine the sensing charging parameter according to the sensing request parameter.

13. The method according to claim 12, wherein the sensing request parameter comprises one or more of following parameters: a sensing device identifier, a sensing event type, sensing time information, sensing location information, sensing range information, sensing accuracy information, sensing frequency information, and a sensing radio access type.

14. The method according to any one of claims 11 to 13, further comprising:
receiving second sensing measurement data sent by the SAF, and obtaining a sensing measurement result.

15. A method for charging, applied to a system for charging, wherein the system for charging comprises a sensing application function (SAF) and a charging function (CHF), and the method comprises:
determining, by the SAF, a sensing charging parameter in response to receiving a sensing request message sent by a sensing requester, and sending the sensing charging parameter to the charging function (CHF), wherein the sensing charging parameter is used to instruct the CHF to perform charging on the sensing requester; and
receiving, by the CHF, the sensing charging parameter, and performing charging on the sensing requester according to the sensing charging parameter.

16. The method according to claim 15, wherein the sensing charging parameter comprises one or more of following parameters: a sensing device identifier, a sensing event type, sensing time information, sensing location information, sensing range information, sensing accuracy information, sensing frequency information, and a sensing radio access type.

17. The method according to claim 15, wherein the sensing request message comprises a sensing request parameter, and the method comprises:
obtaining, by the SAF, the sensing request parameter in response to receiving the sensing request message sent by the sensing requester, and determining the sensing charging parameter according to the sensing request parameter.

18. The method according to any one of claims 15 to 17, further comprising:
establishing, by the CHF, a sensing charging bill for the sensing requester according to the sensing charging parameter, and sending a charging data response message to the SAF in a case that the sensing charging bill is successfully established; and
determining, by the SAF, a sensing execution device in response to receiving the charging data response message sent by the CHF, and sending a sensing execution message to the sensing execution device, wherein the sensing execution message is used to instruct the sensing execution device to perform sensing measurement.

19. The method according to claim 18, further comprising:
sending, by the SAF, second sensing measurement data to the sensing requester in response to receiving first sensing measurement data sent by the sensing execution device.

20. An apparatus for charging, applied to a sensing application function (SAF), wherein the apparatus comprises:
a first determination module, configured to determine a sensing charging parameter in response to receiving a sensing request message sent by a sensing requester; and
a first sending module, configured to send the sensing charging parameter to a charging function (CHF), wherein the sensing charging parameter is used to instruct the CHF to perform charging on the sensing requester.

21. An apparatus for charging, applied to a charging function (CHF), wherein the apparatus comprises:
a second receiving module, configured to receive a sensing charging parameter sent by a sensing application function (SAF), wherein the sensing charging parameter is a parameter determined by the SAF in response to receiving a sensing request message sent by a sensing requester; and
a second charging module, configured to perform charging on the sensing requester according to the sensing charging parameter.

22. An apparatus for charging, applied to a sensing requester, wherein the apparatus comprises:
a third sending module, configured to send a sensing request message to a sensing application function (SAF), wherein the sensing request message is used to instruct the SAF to determine a sensing charging parameter, and the sensing charging parameter is used by a charging function (CHF) to perform charging on the sensing requester.

23. A system for charging, comprising:
a sensing application function (SAF), configured to determine a sensing charging parameter in response to receiving a sensing request message sent by a sensing requester, and send the sensing charging parameter to a charging function (CHF), wherein the sensing charging parameter is used to instruct the CHF to perform charging on the sensing requester; and
a charging function (CHF), configured to receive the sensing charging parameter, and perform charging on the sensing requester according to the sensing charging parameter.

24. An apparatus for charging, comprising:
a processor; and
a memory, configured to store an instruction executable by the processor;
wherein the processor is configured to perform steps of the method according to any one of claims 1 to 6, or the processor is configured to perform steps of the method according to any one of claims 7 to 10, or the processor is configured to perform steps of the method according to any one of claims 11 to 14.

25. A computer-readable storage medium, wherein a computer program instruction is stored on the computer-readable storage medium; when the computer program instruction is executed by a processor, steps of the method according to any one of claims 1 to 6 are implemented; or, when the computer program instruction is executed by a processor, steps of the method according to any one of claims 7 to 10 are implemented; or, when the computer program instruction is executed by a processor, steps of the method according to any one of claims 11 to 14 are implemented.

26. A chip, comprising a processor and an interface, wherein the processor is configured to read an instruction to perform steps of the method according to any one of claims 1 to 6, or the processor is configured to read an instruction to perform steps of the method according to any one of claims 7 to 10, or the processor is configured to read an instruction to perform steps of the method according to any one of claims 11 to 14.
